(19) United States
(12) Patent Application Publication
(10) Pub. No.: US 2018/0329469 A1
(43) Pub. Date: Nov. 15, 2018

(54) POWER-LOSS PROTECTION FOR PLUG-IN MODULE

(71) Applicant: HEWLETT PACKARD ENTERPRISE DEVELOPMENT LP, Houston, TX (US)

(72) Inventors: Chanh V Hua, Houston, TX (US); Michael Stearns, Cypress, TX (US)

(21) Appl. No.: 15/775,824

(22) PCT Filed: Jan. 20, 2016
(86) PCT No.: PCT/US2016/014065

§ 371 Date: May 11, 2018

(51) Int. Cl. G06F 1/30; G06F 1/28; G06F 3/06

(52) U.S. Cl. CPC G06F 1/30; G06F 3/0601; G06F 1/28

(57) ABSTRACT

One example includes a power-loss protection (PLP) module. The module includes a data bus and a plurality of connectors to enable removable coupling between a receptacle of a computer system and a plug-in module to provide electrical connectivity between the computer system and the plug-in module via the data bus. The module also includes a PLP controller to detect a power-loss event associated with the computer system and to provide auxiliary power on a power bus conductively interconnecting the computer system and the plug-in module in response to detecting the power-loss event.

### BACKGROUND

Computer systems often implement peripheral devices that can be modularly plugged-in to the computer system to expand the computer systems functional capabilities. Examples of peripheral devices can include input/output devices, control devices, and modular memory. Some plug-in modules can be modules that include a non-volatile memory storage that can store data and retain the data even in the absence of power. Writing data to a non-volatile storage can sometimes be a relatively lengthy process that can occupy processing resources of a computer system before verifying that the data write is complete. As an example, some peripheral modules include a buffer and a non-volatile storage, such that the buffer receives data provided from the computer system in an expedient manner and, in turn, begins the slower process of writing the data to the non-volatile storage after providing an acknowledgement to the computer system. Therefore, the processing resources of the computer system can be dedicated to other functions while the data is written to the non-volatile storage.

### BRIEF DESCRIPTION OF THE DRAWINGS

FIG. 1 illustrates an example of a memory module system.

FIG. 2 illustrates an example of a power-loss protection (PLP) module.

FIG. 3A is an assembly view illustrating an example diagram of coupling a module system to a system.

FIG. 3B illustrates an example diagram of a module system of FIG. 3A coupled to the system.

FIG. 4 illustrates an example of a system.

FIG. 5 illustrates an example of a method for providing power-loss protection for a module system.

### DETAILED DESCRIPTION

A power-loss protection (PLP) module interconnects a receptacle for a computer system, such as a server, and a plug-in memory module that includes a memory buffer and a non-volatile storage. The PLP module includes a data bus and a connector that is configured to plug in to the receptacle of the computer system, and includes a receptacle that is configured to receive a connector associated with the memory module, such that the PLP module provides conductive connectivity of the memory module to the computer system via the data bus. The PLP module is configured to detect a power-loss event associated with the computer system, such that the PLP module can provide an auxiliary power on a power bus that interconnects the receptacle of the computer system and the memory module to maintain power on the memory module. As a result, the memory module can use the auxiliary power to maintain memory write operations from the buffer to the non-volatile storage during a power-loss event.

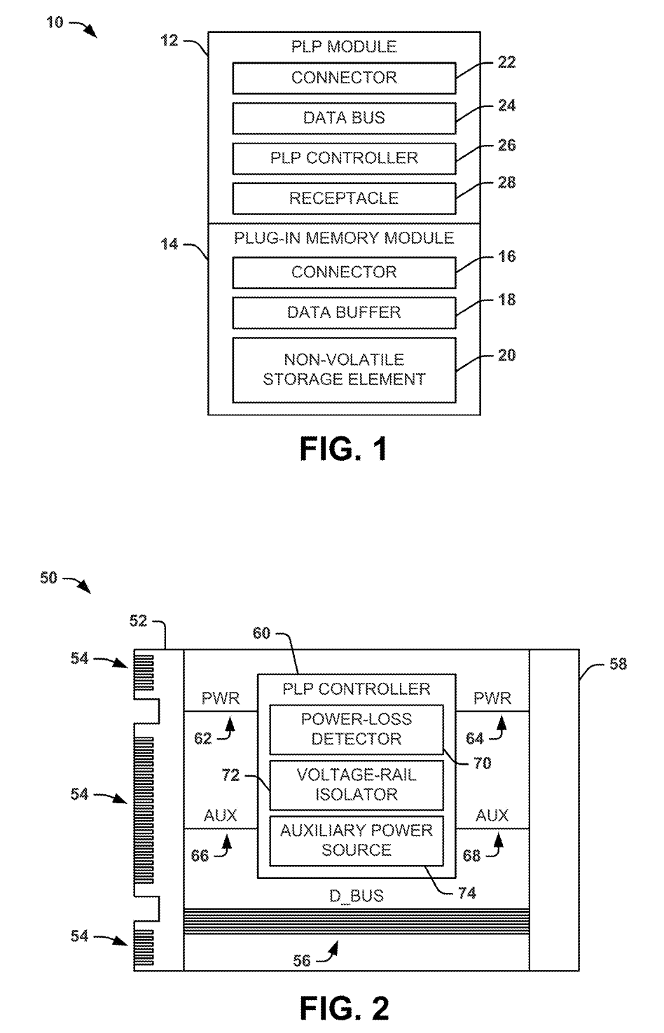

FIG. 1 illustrates an example block diagram of a memory module system 10. The memory module system 10 can be implemented in any of a variety of computer systems, such as a personal computer, laptop computer, or enterprise server, to provide expanded modular memory for the associated computer system. As an example, the memory module system 10 can correspond to an M.2 memory system, such as for plug-in into an M.2 connection system.

The memory module system 10 includes a power-loss protection (PLP) module 12 and a plug-in memory module 14. As an example, the plug-in memory module 14 can correspond to an M.2 memory module. The plug-in memory module 14 includes a connector 16, a data buffer 18, and a non-volatile storage element 20. The connector 16 can correspond to a standard connector for being plugged in to a computer system, such as an M.2 connection system. The data buffer 18 can thus correspond to a temporary destination for data received from the associated computer system to be written to the non-volatile storage element 20, which can thus store the data in the absence of power. For example, the data buffer 18 can provide an acknowledgement to the computer system that the data was received, and can thus subsequently begin writing the data to the non-volatile storage element 20. Accordingly, the processing resources of the associated computer system can be dedicated to other functions while the data is written to the non-volatile storage element 20.

The PLP module 12 can be arranged to interconnect the plug-in memory module 14 and the associated computer system, such that the plug-in memory module 14 can plug in to the PLP module 12 instead of the associated computer system. The PLP module 12 can thus be configured to detect a power-loss event associated with the computer system and to provide auxiliary power to the plug-in memory module 14 in response to detecting the power-loss event. Therefore, in the event of a power-loss condition associated with the computer system, the plug-in memory module 14 can be provided sufficient power to complete the writing of the data from the data buffer 18 to the non-volatile storage element 20 to ensure that the data is preserved.

In the example of FIG. 1, the PLP module 12 includes a connector 22, a data bus 24, a PLP controller 26, and a receptacle 28. The connector 22 is configured to facilitate plug-in of the PLP module 12 into a receptacle associated with the computer system, and the receptacle 28 is configured to facilitate plug-in of the connector 16 of the plug-in memory module 14 into the PLP module 12. The data bus 24 can conductively interconnect the connector 22 and the receptacle 28 to provide electrical connectivity of the connector 16 of the plug-in memory module 14 with the computer system. As an example, the connector 16 and the connector 22 can be dimensioned and configured to be substantially identical. The receptacle 28 and the receptacle of the associated computer system can likewise be dimensioned and configured substantially identically. Therefore, the plug-in memory module 14 can be substantially agnostic with respect to the PLP module 12, allowing the plug-in memory module 14 to be configured as an off-the-shelf memory module configured to plug directly into the associated computer system. Accordingly, the PLP module 12 can be configured to interconnect the associated computer system and the plug-in memory module 14 to provide the PLP capability described herein.

The PLP controller 26 is configured to implement PLP functionality of the plug-in memory module 14. As an example, the PLP controller 26 can be configured to detect a power-loss event associated with the computer system. In response to detecting the power-loss event, the PLP controller 26 can provide auxiliary power from an associated internal power source on a power bus to maintain an uninterrupted supply of power on the plug-in memory module 14. For example, the PLP controller 26 can include a voltage-rail isolator that separates the power bus into a first portion coupled to the computer system and a second portion coupled to the plug-in memory module 14. Therefore, in response to detecting the power-loss event on the first portion of the power bus, the voltage-rail isolator can isolate the first and second portions of the power bus to provide the auxiliary power on the second portion of the power bus. Accordingly, in response to the PLP controller 26 detecting the power-loss event, the PLP module 12 can supply auxiliary power to plug-in memory module 14 to complete the writing of any data stored in the buffer 18 to the non-volatile storage element 20 to ensure that the data is preserved.

While the PLP module 12 and the plug-in memory module 14 are demonstrated as having a combination of connectors (e.g., the connectors 16 and 22) and receptacles (e.g., the receptacle of the associated computer system and the receptacle 28), it is to be understood that the memory module system 10 is not limited to the arrangement demonstrated in the example of FIG. 1. As described herein, the term “connector” describes a manner of connecting components of the memory module system 10 with respect to the PLP module 12 to the computer system or the plug-in memory module 14 to the PLP module 12. Thus, the term “connector” is not limited to a male connector, but could instead refer to a female connector (e.g., receptacle) or other connection means. Therefore, the memory module system 10 can be implemented to include any of a variety of conductive coupling means. In addition, while the example of FIG. 1 demonstrates the use of the PLP module 12 with a memory module (e.g., the memory module 14), it is to be understood that the PLP module 12 can be used with any type of plug-in module to provide auxiliary power in the event of a power-loss condition. Therefore, the PLP module 12 is not limited to use with memory modules alone.

FIG. 2 illustrates an example of a PLP module 50. The PLP module 50 can correspond to the PLP module 12 in the example of FIG. 1. Therefore, reference is to be made to the example of FIG. 1 in the following description of the example of FIG. 2.

The PLP module 50 includes a connector 52 that includes a plurality of conductive connector elements 54. In the example of FIG. 2, the connector 52 is demonstrated as a slot connector, such that the conductive connector elements 54 correspond to electrically conductive fingers (e.g., gold fingers) that are patterned as respective terminals on a surface of the slot connector. However, it is to be understood that the connector 52 can be arranged in a variety of different ways. For example, the conductive connector elements 54 can instead be configured as pins. The PLP module 50 also includes a data bus 56 (“D_BUS”) that extends between the connector 52 and a receptacle 58, demonstrated in the example of FIG. 2 as a straddle-mount receptacle. Thus, the data bus 56 provides conductive connectivity between the connector 52 and the receptacle 58 in a pass-through manner, such that the connector 52 and the receptacle 58 can be configured substantially the same with respect to the arrangement of conductors, such that the receptacle 58 can be arranged substantially identically to a receptacle of an associated computer system.

The PLP module 50 also includes a PLP controller 60 that interconnects a first power bus portion 62 and a second power bus portion 64, as well as a first auxiliary bus portion 66, and a second auxiliary bus portion 68. As an example, the first and second power bus portions 62 and 64 can provide power (“PWR”) to the associated plug-in memory module (e.g., the plug-in memory module 14) from the computer system during normal operation, and the first and second auxiliary bus portions 66 and 68 can be associated with any of a variety of auxiliary signals (“AUX”; e.g., a device sleep signal) between the computer system and the associated plug-in memory module. The first and second power bus portions 62 and 64 and the first and second auxiliary bus portions 66 and 68 can interconnect the connector 52 and the receptacle 58 via the PLP controller 60, such that a set of the conductive connector elements 54 can correspond to the first and second power bus portions 62 and 64 and a respective set of conductive receptacle elements of the receptacle 58 can correspond to the first and second auxiliary bus portions 66 and 68.

In the example of FIG. 2, the PLP controller 60 includes a power-loss detector 70, a voltage-rail isolator 72, and an auxiliary power source 74. The power-loss detector 70 can be configured to monitor a voltage on the first power bus portion 62 that is electrically coupled to the computer system. As an example, in response to detecting that the voltage on the first power bus portion 62 decreases less than a predetermined threshold, the power-loss detector 70 can detect the occurrence of a power-loss event.

The voltage-rail isolator 72 is configured to isolate the first and second power bus portions 62 and 64 and the first and second auxiliary bus portions 66 and 68, respectively, in response to a power-loss event. For example, during normal operation of the computer system, the voltage-rail isolator 72 can provide electrical connectivity between the first and second power bus portions 62 and 64 and between the first and second auxiliary bus portions 66 and 68. However, in response to receiving indication of the power-loss event from the power-loss detector 70, the voltage-rail isolator 72 can isolate the first and second power bus portions 62 and 64 and the first and second auxiliary bus portions 66 and 68 in response to detecting the power-loss event. Thus, the auxiliary power source 74 can provide the auxiliary power (e.g., auxiliary voltage) on the second power bus portion 64, such as to maintain power on the associated plug-in memory module.

For example, the auxiliary power source 74 can include an arrangement of one or more capacitors configured to store energy, such as received from the first power bus portion 62 during normal operation of the computer system, and to provide the stored energy as the auxiliary power during the power-loss event. As another example, the second auxiliary bus portion 68 can provide one or more signals to the associated plug-in memory module, such as via the auxiliary power provided from the auxiliary power source 74, in response to the detected power-loss event. Accordingly, in response to the power-loss detector 70 detecting the power-loss event, the associated plug-in memory module can be provided the auxiliary power and signals via the second power bus portion 64 and the second auxiliary bus portion 68 to complete the writing of any data stored in the buffer to the respective non-volatile storage element to ensure that the data is preserved.

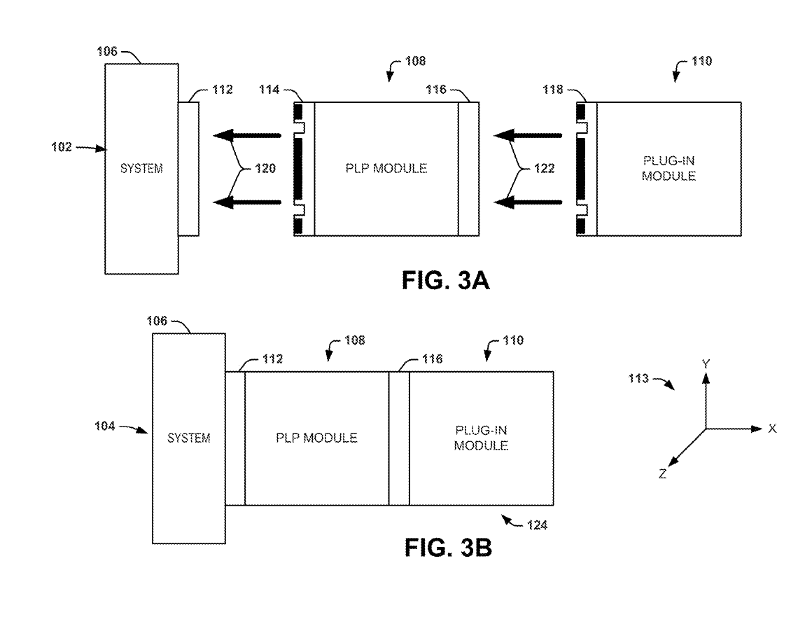

FIGS. 3A and 3B illustrate an example of coupling a module system to a system. In FIG. 3A, the module system is demonstrated in an exploded assembly view 102 and as an assembled view 104 in FIG. 3B. As shown in FIGS. 3A and 3B, each of the views 102 and 104 includes a system 106 (e.g., a computer system or part of a computer system), a PLP module 108, and a plug-in module 110. The PLP module 108 and the plug-in module 110 can collectively correspond to a module system, such as the memory module system 10 in the example of FIG. 1. As an example, the PLP module 108 can be configured substantially the same as the PLP module 12 in the example of FIG. 1 and/or the PLP module 50 in the example of FIG. 2, and the plug-in module 110 can be configured substantially the same as the plug-in memory module 14 in the example of FIG. 1. Therefore, reference is to be made to the examples of FIGS. 1 and 2 in the following description of the example of FIG. 3.

In the example of FIGS. 3A and 3B, the system 106 can correspond to an enterprise server computer, such that the system 106 includes a receptacle 112 that can correspond to one of a plurality of receptacles arranged in a stacked array (e.g., a column or row), such as along a Z-axis as indicated by a Cartesian coordinate system 113. Additionally, the PLP module 108 includes a connector 114 and a receptacle 116, and the plug-in module 110 includes a connector 118. The exploded view 102 demonstrates that the PLP module 108 plugs in to the system 106 via the connector 114 and the receptacle 112, as indicated by arrows 120 (e.g., in the direction of the X-axis of the coordinate system 113), and the plug-in module 110 plugs in to the PLP module 108 via the connector 118 and the receptacle 116, as indicated by arrows 122 (e.g., in the direction of the X-axis of the coordinate system 113). Accordingly, the assembled view 104 demonstrates a module system 124 corresponding to the PLP module 108 and the plug-in module 110 having been plugged into the system 106.

The receptacle 112 of the system 106 can be arranged substantially identically with respect to the receptacle 116 of the PLP module 108. Similarly, the connector 114 of the PLP module 108 can be arranged substantially identically with respect to the connector 118 of the plug-in module 110. Therefore, the plug-in module 110 can be substantially agnostic with respect to the PLP module 108, such that the functionality of the plug-in module 110 is unimpeded by the interposing PLP module 108, and is instead enhanced by the PLP functionality provided by the PLP module 108.

As described previously, the plug-in module 110 can be configured as an off-the-shelf module that can typically be configured to plug directly into the associated computer system. Thus, the PLP module 108 can be dimensioned to be substantially similar to the plug-in module 110, such as along both the Y-direction and the Z-direction (e.g., the dimensions of a typical M.2 module). Therefore, the PLP module 108 can be fabricated such that the module system 124 that is formed by the PLP module 108 and the plug-in module 110 can maintain dimensional specifications to facilitate coupling of multiple module systems 124 or other devices in the system 106 on separate respective receptacles (e.g., arranged the same as the receptacle 112 along the Z-axis).

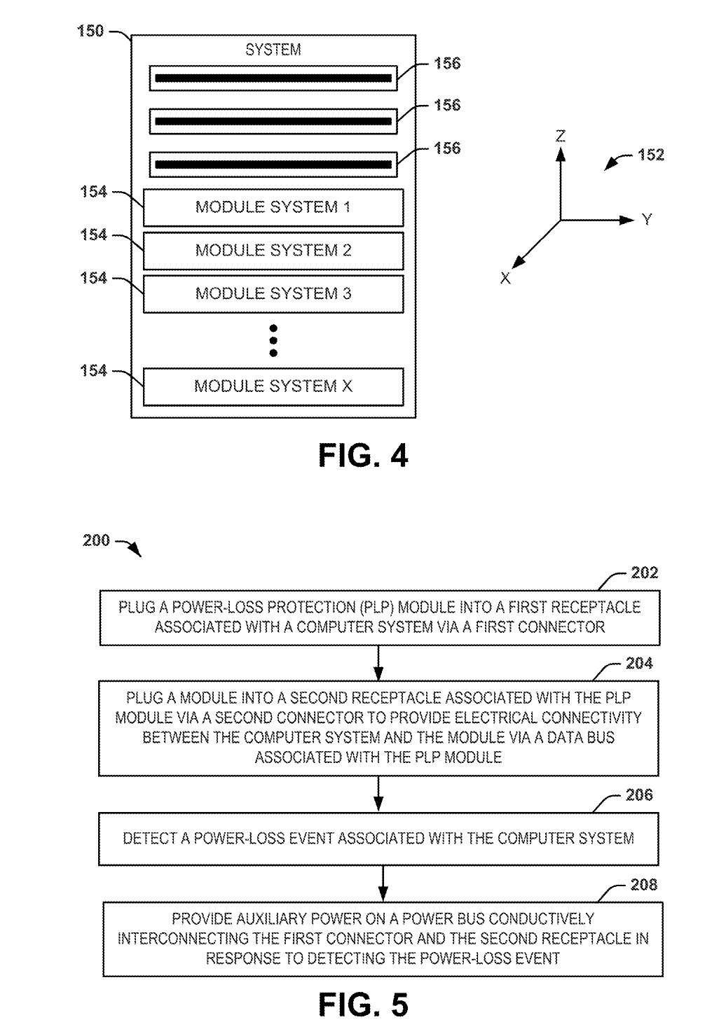

FIG. 4 illustrates an example of a system 150. The system 150 can correspond to the system 106 in the example of FIGS. 3A and 3B, or a portion of a computer system. Therefore, reference is to be made to the example of FIGS. 3A and 3B in the following description of the example of FIG. 4. The example of FIG. 4 includes a Cartesian coordinate system 152 to demonstrate a different perspective view in the same coordinate space of a plurality X of module systems 154 that are plugged into the system 150, with X being a positive integer. Each of (or at least one of) the module systems 154 can be configured substantially similar to the module system 124 in the example of FIGS. 3A and 3B. In the example of FIG. 4, the system 150 includes a column of receptacles 156 (e.g., demonstrated as saddle-mount connectors) that are each configured to receive a connector (e.g., the connector 114) of a respective PLP module of the module systems 154. As demonstrated in the example of FIG. 4, the dimensions of the PLP module of each of the module systems 154 is such that the module systems 154 can maintain dimensional specifications to facilitate coupling of multiple module systems 154 via adjacent receptacles 156. Therefore, the module systems 154 can each incorporate PLP functionality based on respective PLP modules (e.g., the PLP module 108) in a space-efficient manner, as opposed to after-market modifications in which bulky capacitors are wired to off-the-shelf modules, which can limit the number of devices plugged into the system 150 based on Z-dimension constraints.

Referring back to the example of FIGS. 3A and 3B, as another example, the PLP module 108 can also be fabricated to have a length along the X-axis that can maintain specifications for suitable lengths of the off-the-shelf plug-in module 110. For example, the PLP module 108 can have a length such that, when combined with the length of the plug-in module 110, can result in a length of the module system 124 corresponding to typical lengths of approximately 60 mm, 80 mm, and 110 mm of off-the-shelf plug-in modules (e.g., the dimensions of a typical M.2 module). Therefore, the addition of the PLP module 108 can be such that the length of the module system 124 is not space-prohibitive, such as by restricting enclosure in a cabinet that includes the system 106. Accordingly, the PLP module 108 can be implemented as a retrofit to existing legacy computer systems without substantial modification.

In view of the foregoing structural and functional features described above, an example methodology will be better appreciated with reference to FIG. 5. While, for purposes of simplicity of explanation, the methodology of FIG. 5 is shown and described as executing serially, it is to be understood and appreciated that the present invention is not limited by the illustrated order, as some embodiments could in other embodiments occur in different orders and/or concurrently from that shown and described herein.

FIG. 5 illustrates an example embodiment of a method 200 for providing power-loss protection for a plug-in module (e.g., the memory module system 10). At 202, a PLP module (e.g., the PLP module 12) is plugged into a first receptacle (e.g., the receptacle 112) associated with a computer system via a first connector (e.g., the connector 22). At 204, a module (e.g., the plug-in memory module 14) is plugged into a second receptacle (e.g., the receptacle 28) associated with the PLP module via a second connector (e.g., the connector 16) to provide electrical connectivity between the computer system and the module via a data bus (e.g., the data bus 26) associated with the PLP module. At 206, a power-loss event associated with the computer system is detected (e.g., via the power-loss detector 70). At 208, auxiliary power is provided on a power bus (e.g., the second power bus portion 64) conductively interconnecting the first connector and the second receptacle in response to detecting the power-loss event.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. An apparatus comprising:
a data bus;
a plurality of connectors to enable removable coupling between a receptacle of a computer system and a plug-in module to provide electrical connectivity between the computer system and the plug-in module via the data bus; and
a power-loss protection (PLP) controller to detect a power-loss event associated with the computer system and to provide auxiliary power on a power bus conductively interconnecting the computer system and the plug-in module in response to detecting the power-loss event.

2. The apparatus of claim 1, wherein the plurality of connectors comprises:
a plug-in connector to plug-in to a receptacle associated with the computer system; and
a module receptacle to receive a connector associated with the plug-in module.

3. The apparatus of claim 2, wherein the plug-in connector comprises a plurality of conductive connector elements, and wherein the receptacle comprises a plurality of conductive receptacle elements that are associated with the respective plurality of conductive connector elements, such that the receptacle associated with the computer system is arranged substantially the same as the module receptacle.

4. The apparatus of claim 1, wherein the PLP controller comprises a voltage-rail isolator to isolate the power bus conductively interconnecting the receptacle and the plug-in module, such that the power bus comprises a first power bus interconnecting the computer system and the voltage-rail isolator and a second power bus interconnecting the voltage-rail isolator and the plug-in module, the PLP controller being to provide the auxiliary power on the second power bus in response to detecting the power-loss event.

5. The apparatus of claim 1, further comprising an auxiliary bus that interconnects the computer system and the plug-in module via the PLP controller.

6. The apparatus of claim 1, wherein the plug-in module is an M.2 module, wherein the apparatus has a cross-sectional dimension that is approximately the same as the M.2 module to enable plug-in of the apparatus into a computer system in a receptacle between devices that are plugged-in to adjacent receptacles of the computer system.

7. A memory module system comprising the apparatus of claim 1 and the plug-in module, wherein the plug-in module is configured as a memory module comprising:
a connector to plug-in to one of the plurality of connectors associated with the apparatus;
a buffer to receive data from the computer system; and
a non-volatile storage to receive the data from the buffer.

8. A method comprising:
plugging a power-loss protection (PLP) module into a first receptacle associated with a computer system via a first connector;
plugging a module into a second receptacle associated with the PLP module via a second connector to provide electrical connectivity between the computer system and the module via a data bus associated with the PLP module;
detecting a power-loss event associated with the computer system; and
providing auxiliary power on a power bus conductively interconnecting the first connector and the second receptacle in response to detecting the power-loss event.

9. The method of claim 8, wherein the first connector comprises a first plurality of conductive connector elements that are conductively coupled to a respective first plurality of conductive receptacle elements of the first receptacle, and wherein the second connector comprises a respective second plurality of conductive connector elements that are conductively coupled to a respective second plurality of conductive receptacle elements of the second receptacle.

10. The method of claim 9, wherein the first plurality of conductive connector elements is arranged substantially the same as the second respective plurality of conductive connector elements with respect to size, location, and relative spacing.

11. The method of claim 8, wherein the power bus comprises a first power bus interconnecting the first connector and a voltage-rail isolator associated with the PLP module and a second power bus interconnecting the voltage-rail isolator and the second receptacle, wherein providing the auxiliary power comprises:
isolating the first power bus and the second power bus in response to detecting the power-loss event; and
providing the auxiliary power on the second power bus in response to detecting the power-loss event.

12. An apparatus comprising:
a power-loss protection (PLP) module comprising a data bus and a first connector to enable coupling to a first receptacle of a computer system, the PLP module being to detect a power-loss event associated with the computer system and to provide auxiliary power on a power bus in response to detecting the power-loss event; and
a plug-in memory module comprising a non-volatile storage and a second connector to enable coupling to a second receptacle associated with the PLP module to provide electrical connectivity between the computer system and the plug-in memory module via the data bus and the power bus, the plug-in memory module being to store data received from the computer system via the data bus in the non-volatile storage.

13. The apparatus of claim 12, wherein the first connector comprises a plurality of conductive connector elements, and wherein the second receptacle comprises a plurality of conductive receptacle elements that are associated with the respective plurality of conductive connector elements, such that the first receptacle is arranged substantially the same as the second receptacle.

14. The apparatus of claim 12, wherein the PLP controller comprises a voltage-rail isolator to isolate the power bus conductively interconnecting the receptacle and the plug-in memory module, such that the power bus comprises a first power bus interconnecting the computer system and the voltage-rail isolator and a second power bus interconnecting the voltage-rail isolator and the plug-in memory module, the PLP controller being to provide the auxiliary power on the second power bus in response to detecting the power-loss event.

15. The apparatus of claim 12, wherein the plug-in memory module is an M.2 module, wherein the apparatus has a cross-sectional dimension that is approximately the same as the M.2 module to enable plug-in of the apparatus into a computer system in a receptacle between devices that are plugged-in to adjacent receptacles of the computer system.
